(19) United States
(12) Patent Application Publication
(10) Pub. No.: US 2022/0129645 A1
(43) Pub. Date: Apr. 28, 2022

(54) ELECTRONIC DEVICE AND METHOD FOR CONTROLLING SAME

(71) Applicants: Samsung Electronics Co., Ltd., Suwon-si, Gyeonggi-do (KR); New York University, New York, NY (US)

(72) Inventors: Jaedeok KIM, Suwon-si (KR); Sangha KIM, Suwon-si (KR); Yunjae LEE, New York, NY (US); Kyunghyun CHO, New York, NY (US)

(21) Appl. No.: 17/435,554

(22) PCT Filed: Jan. 7, 2021
(86) PCT No.: PCT/KR2021/000210

§ 371 Date: Sep. 1, 2021

(30) Foreign Application Priority Data
Oct. 27, 2020 (KR) 10-2020-0140570

(51) Int. Cl. G06F 40/58; G06N 3/04; G06F 40/47; G06F 40/284

(52) U.S. Cl. CPC G06F 40/58; G06F 40/284; G06F 40/47; G06N 3/0454

(57) ABSTRACT

An electronic device is provided. The electronic device includes an inputter configured to obtain an input sentence in a first language, a memory, and a processor, and the processor is configured to obtain a feature vector corresponding to the input sentence by inputting the input sentence to an encoder model, obtain a first latent vector by inputting the feature vector and a specific integer to an intermediate network, obtain information on a first output sentence in a second language different from the first language by inputting the first latent vector to a decoder model, obtain a second latent vector by inputting the feature vector and the information on the first output sentence to the intermediate network, and obtain information on a second output sentence in the second language by inputting the second latent vector to the decoder model.

### CROSS-REFERENCE TO RELATED APPLICATION(S)

This application is a U.S. National Stage application under 35 U.S.C. § 371 of an International application number PCT/KR2021/000210, filed on Jan. 7, 2021, which is based on and claimed priority of a Korean patent application number 10-2020-0140570, filed on Oct. 27, 2020, in the Korean Intellectual Property Office, the disclosure of which is incorporated by reference herein in its entirety.

### JOINT RESEARCH AGREEMENT

The disclosure was made by or on behalf of the below listed parties to a joint research agreement. The joint research agreement was in effect on or before the date the disclosure was made and the disclosure was made as a result of activities undertaken within the scope of the joint research agreement. The parties to the joint research agreement are 1) SAMSUNG ELECTRONICS CO., LTD and 2) NEW YORK UNIVERSITY.

### BACKGROUND

### 1. Field

The disclosure relates to an electronic device and a method for controlling the same. More particularly, the disclosure relates to an electronic device which obtains an output sentence by performing machine translation for an input sentence and a method for controlling the same.

### 2. Description of Related Art

An artificial intelligence (AI) system is a computer system which realizes human-level intelligence, and is a system in which a machine trains, determines, and becomes smarter by itself, unlike a rule-based smart system of the related art. As the artificial intelligence system is used, a recognition rate is improved and preferences of a user can be more accurately understood, and thus, the rule-based smart system of the related art is gradually being replaced with the deep learning-based artificial intelligence system.

In recent years, research for a machine translation model using artificial intelligence has been actively proceeded. A representative model of the machine translation may be a model called a transformer, but the transformer performs translation by a sequence-to-sequence method, that is, in a token unit, which has a limit in processing time. In order to overcome such a limit, the research for a technology of performing the translation in a sentence unit has been conducted, but it is necessary to add a separate network for generating a latent vector which is an input for a decoder, thereby resulting in an increase in size of a model and an increase in memory usage.

Therefore, it is necessary to provide a translation model for minimizing a translation processing time and a memory usage.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a translation model capable of minimizing a translation processing time and a memory usage.

Additional aspects will be set forth in part in the description which follows and, in part, will be apparent from the description, or may be learned by practice of the presented embodiments.

In accordance with an aspect of the disclosure, an electronic device is provided. The electronic device includes an inputter configured to obtain an input sentence in a first language, a memory storing at least one instruction, and a processor, in which the processor is configured to obtain a feature vector corresponding to the input sentence by inputting the input sentence to an encoder model, obtain a first latent vector by inputting the feature vector and a specific integer to an intermediate network, obtain information on a first output sentence in a second language different from the first language by inputting the first latent vector to a decoder model, obtain a second latent vector by inputting the feature vector and the information on the first output sentence to the intermediate network, and obtain information on a second output sentence in the second language by inputting the second latent vector to the decoder model.

In accordance with another aspect of the disclosure, a method for controlling an electronic device is provided. The method includes obtaining an input sentence in a first language, obtaining a feature vector by inputting the input sentence to an encoder model, obtaining a first latent vector by inputting the feature vector and a specific integer to an intermediate network, obtaining information on a first output sentence in a second language different from the first language by inputting the first latent vector to a decoder model, obtaining a second latent vector by inputting the feature vector and the information on the first output sentence to the intermediate network, and obtaining information on a second output sentence in the second language by inputting the second latent vector to the decoder model.

According to various embodiments of the disclosure, the electronic device may provide a translated sentence to a user while minimizing a translation processing time and a memory usage. Accordingly, the electronic device may efficiently use the memory.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a concept of an electronic device according to an embodiment of the disclosure;

FIG. 2 is a diagram illustrating a non-autoregressive translation model according to an embodiment of the disclosure;

FIG. 3 is a diagram illustrating a translation model according to an embodiment of the disclosure;

FIG. 4 is a diagram illustrating a translation model according to an embodiment of the disclosure;

FIG. 5 is a block diagram illustrating a configuration of an electronic device according to an embodiment of the disclosure; and

FIG. 6 is a flowchart illustrating a method for controlling an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The embodiments of the disclosure may be variously changed and include various embodiments, and specific embodiments will be shown in the drawings and described in detail in the description. However, it should be understood that this is not to limit the scope of the specific embodiments and all modifications, equivalents, and/or alternatives included in the disclosed spirit and technical scope are included. In describing the disclosure, a detailed description of the related art may be omitted when it is determined that the detailed description may unnecessarily obscure a gist of the disclosure.

The terms “first,” “second,” or the like may be used for describing various elements but the elements may not be limited by the terms. The terms are used only to distinguish one element from another.

Unless otherwise defined specifically, a singular expression may encompass a plural expression. It is to be understood that the terms such as “comprise” or “consist of” are used herein to designate a presence of characteristic, number, operation, element, part, or a combination thereof, and not to preclude a presence or a possibility of adding one or more of other characteristics, numbers, operations, elements, parts or a combination thereof.

Hereinafter, with reference to the accompanying drawings, embodiments of the disclosure will be described in detail for those skilled in the art to easily practice the embodiments. But, the disclosure may be implemented in various different forms and is not limited to the embodiments described herein. In addition, in the drawings, the parts not relating to the description are omitted for clearly describing the disclosure, and the same reference numerals are used for the same parts throughout the specification.

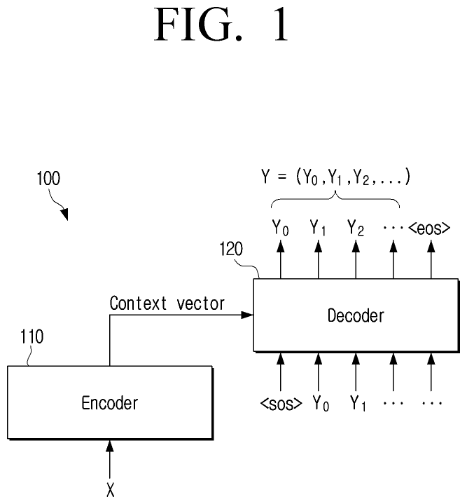

FIG. 1 is a diagram illustrating an autoregressive translation model according to an embodiment of the disclosure.

Referring to FIG. 1, a translation model 100 of the related art which is a so-called sequence-to-sequence model or autoregressive translation model may obtain a context vector by inputting an input sentence X to an encoder 110. The translation model 100 may input the context vector to a decoder 120 to sequentially obtain a plurality of tokens (or words) Y₀, Y₁, and Y₂ configuring an output sentence Y. Specifically, the translation model 100 may obtain a first token by inputting a symbol <sos> which means the start of the sentence and the context vector to the decoder 120 at a first time point. The translation model 100 may input the first token Y₀ to the decoder 120 at a second time point to obtain the second token Y₁. In the same manner, the translation model 100 may input the second token Y₁ to the decoder 120 at a third time point to obtain the third token Y₂. The translation model 100 may repeat this operation until a symbol (e.g., <eos>) which means the end of the sentence is obtained as output of the decoder 120.

As described above, the translation model 100 obtains the output sentence in sequence in the token unit. Accordingly, since the plurality of tokens configuring the output sentence may not be obtained at the same time, there is a problem of a long period of time required to obtain the output sentence.

In order to solve this problem, a translation model which is a so-called non-autoregressive translation model has been developed. The non-autoregressive translation model may obtain the output sentence in a sentence unit, unlike the autoregressive translation model which obtains the output sentence in sequence in the token unit. Accordingly, the non-autoregressive translation model is advantageous that a translation processing speed is faster compared to the autoregressive translation model.

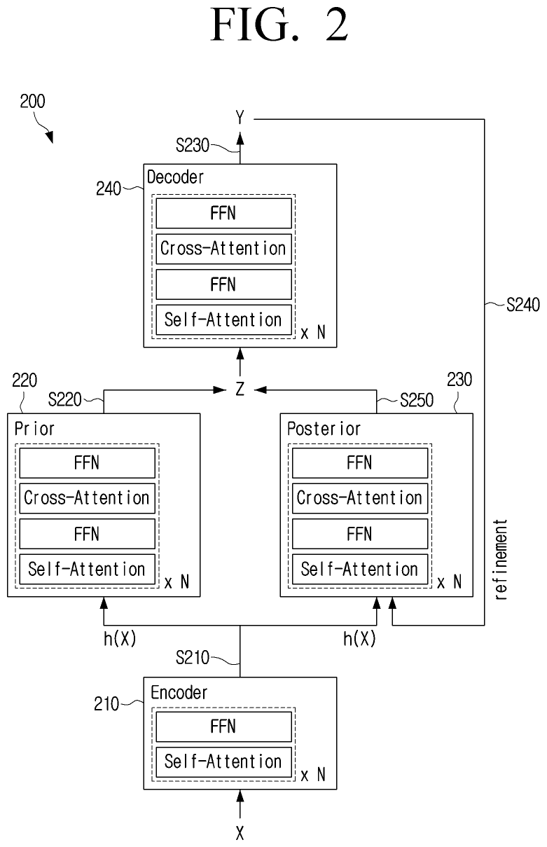

FIG. 2 is a diagram illustrating a non-autoregressive translation model according to an embodiment of the disclosure.

Referring to FIG. 2, a translation model 200 may input an input sentence X in a first language to an encoder 210 to obtain a feature vector h(x) (S210). The translation model 200 may input the feature vector h(X) to a prior model 220 to obtain a latent vector Z (S220). The prior model 220 may be a model for obtaining the latent vector (or latent variable) Z which is an input value of a decoder 240, and the latent vector Z may refer to a vector indicating a feature for the input sentence X. The prior model 220 may include a plurality of neural networks and layers. For example, the prior model 220 may include attention layers (self-attention and cross-attention) based on an attention mechanism. Herein, the attention layer is a layer for analyzing a relationship between other words for each word (or token) included in the input sentence X to determine which word is to be focused on. The prior model 220 may obtain a weight for each word included in the input sentence X through the attention layer. In addition, the prior model 220 may include a feed-forward network (FNN) for adjusting a size (or dimension) of the latent vector Z.

The translation model 200 may input the latent vector Z to the decoder 240 to obtain a first output sentence Y in a second language that is different from the first language (S230). The translation model 200 may input the first output sentence Y and the feature vector h(X) to a posterior model 230 to obtain a second latent vector Z′ (S250). The translation model 200 may input the second latent vector Z′ to the decoder 240 to obtain a second output sentence Y′ (S260) (not illustrated). The translation model 200 may repeat the operations S240, S250, and S260 until a difference between a first vector value corresponding to the first output sentence Y and a second vector value corresponding to the second output sentence Y′ is equal to or less than a predetermined value. In other words, the translation model 200 may repeatedly obtain a new output sentence based on the output sentence obtained at a previous time point until the output sentence is improved, and such a process may refer to a refinement process for the output sentence.

Meanwhile, the translation model 200 of FIG. 2 has an advantage of a faster translation processing speed than the translation model 100 of FIG. 1, but has a disadvantage that the memory usage increases due to the addition of the prior model 220 and the posterior model 230. Such a disadvantage leads to a problem that the translation model 200 is difficult to be applied to a device with a limited memory capacity such as a smartphone. In order to solve such a problem, the translation model according to the disclosure may be implemented as an integrated type of the prior model and the posterior model.

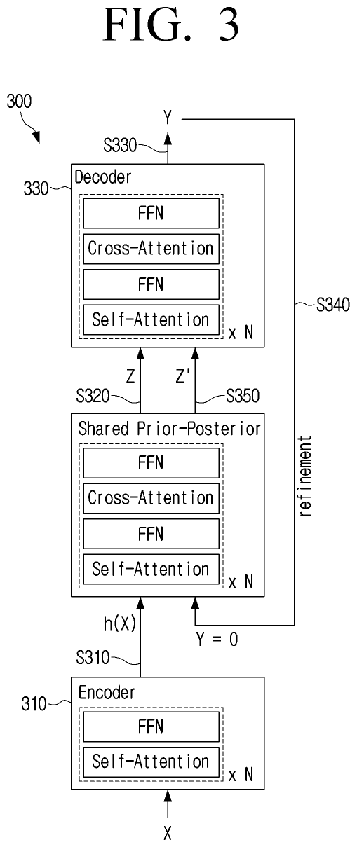

FIG. 3 is a diagram illustrating a translation model according to an embodiment of the disclosure. A translation model 300 may include an encoder 310, an intermediate network 320, and a decoder 330. The translation model 300 may be implemented as a neural network.

Referring to FIG. 3, a translation model 300 may input an input sentence X in a first language to an encoder 310 to obtain a feature vector h(X) (S310). The operation of inputting the input sentence X in the first language to the encoder 310 may include an operation of obtaining a vector for the input sentence X based on a text for the input sentence X, and inputting the obtained vector to an input layer (not illustrated). In this case, the translation model 300 may obtain a vector corresponding to the input sentence X based on word2vec or word embedding. Meanwhile, the input layer may be included in the encoder 310.

The encoder 310 may include a self-attention layer and a feed-forward network (FNN). The encoder 310 may input the input sentence X to the self-attention layer to obtain a weight vector indicating a weight for each of the words included in the input sentence X. The encoder 310 may input the weight vector to the feed-forward network (FNN) to obtain the feature vector h(X).

The translation model 300 may input the feature vector h(X) and a specific integer to the intermediate network 320 to obtain a first latent vector Z (S320). Herein, the specific integer may be 0. The intermediate network 320 may include at least one attention layer and at least one feed-forward network. For example, the intermediate network 320 may include attention layers including a self-attention layer and a cross-attention layer and the feed-forward network. In this case, the translation model 300 may input the feature vector h(X) and 0 to the self-attention layer, the first feed-forward network, the cross-attention layer, and the second feed-forward network in sequence to obtain the latent vector Z.

Meanwhile, the intermediate network 320 may perform the functions corresponding to the prior model 220 and the posterior model 230 of the translation model 200. However, unlike the translation model 200 in which the prior model 220 and the posterior model 230 are configured with separate networks, the networks which perform the functions corresponding to the prior model 220 and the posterior model 230 may be configured as one network in the intermediate network 320. Accordingly, the translation model 300 has an advantage of a smaller size of a model and a smaller memory usage, compared to the translation model 200 of FIG. 2. Accordingly, the translation model 300 may be applied to a device with a limited memory capacity such as a smartphone.

Meanwhile, the translation model 300 may input 0 along with the feature vector h(X) to the intermediate network 320 at the first time point to obtain the latent vector Z, and in the subsequent time point, obtain a new latent vector Z′ by using the output sentence Y obtained through the decoder 330. The process of obtaining the new latent vector Z′ will be described in more detail in the operation S340.

The translation model 300 may input the latent vector Z to the decoder 330 to obtain information on the output sentence Y in the second language (S330). For example, the information on the output sentence Y may refer to a vector corresponding to the output sentence Y. Meanwhile, the first language may be different from the second language. For example, the first language may be English and the second language may be Korean, but there is no limitation thereto.

The decoder 330 may include at least one attention layer and at least one feed-forward network. For example, the decoder 330 may include the attention layer including the self-attention layer and the cross-attention layer and the feed-forward network. The decoder 330 may input the latent vector Z to the self-attention layer, the first feed-forward network, the cross-attention layer, and the second feed-forward network in sequence to obtain the output sentence Y.

When the output sentence Y is obtained, the translation model 300 may perform an operation for updating or refining the output sentence Y. The translation model 300 may input the feature vector h(X) and the information on the output sentence Y to the intermediate network 320 to obtain a new latent vector Z′ (S350). In a case where the output sentence Y obtained at the first time point is the first output sentence Y, the translation model 300 may input the first output sentence Y and the feature vector h(X) to the intermediate network 320 to obtain a new second latent vector Z′.

The translation model 300 may input the second latent vector Z′ to the decoder 330 to obtain information on a new second output sentence Y′ (S360) (not illustrated). The translation model 300 may obtain a similarity between the information on the first output sentence Y and the information on the second output sentence Y′. For example, the translation model 300 may obtain a similarity between a first vector corresponding to the first output sentence Y and a second vector corresponding to the second output sentence Y′. The translation model 300 may repeatedly perform the operations S340, S350, and S360, until the obtained similarity is equal to or more than a predetermined value. Alternatively, the translation model 300 may repeatedly perform the operations S340, S350, and S360 by a predetermined number of times (e.g., five times).

When the obtained similarity is equal to or more than the predetermined value, the translation model 300 may input the information on the output sentence Y to an output layer (not illustrated) to obtain a text corresponding to the output sentence Y. For example, the output layer may include a linear layer and a softmax layer. Herein, the output layer may be included in the decoder 340.

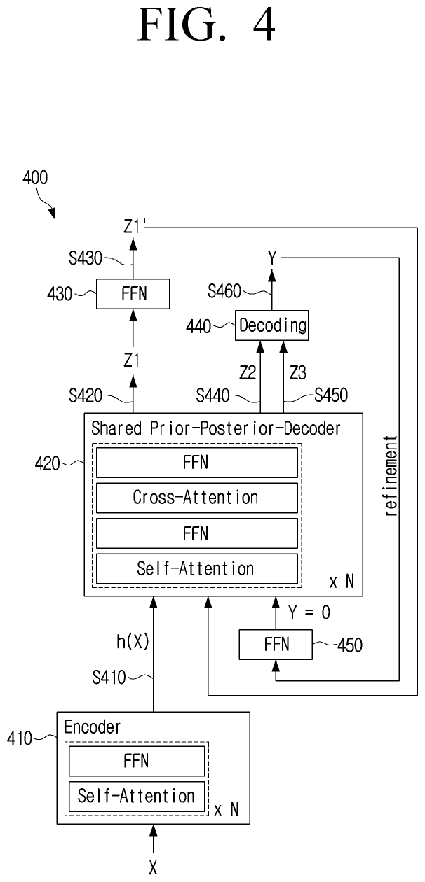

Meanwhile, the intermediate network 320 may be integrated with the decoder 330. FIG. 4 is a diagram illustrating a translation model according to an embodiment of the disclosure. A translation model 400 may include an encoder 410, an intermediate network 420, feed-forward networks 430 and 450, and a decoding block 440.

Referring to FIG. 4, a translation model 400 may input an input sentence X to an encoder 410 to obtain a feature vector h(X) (S410). The encoder 410 may include a self-attention layer and a feed-forward network (FNN). The encoder 410 may input the input sentence X to the self-attention layer to obtain a weight vector indicating a weight for each of words included in the input sentence X. The encoder 410 may input the weight vector to the feed-forward network (FNN) to obtain the feature vector h(X).

The translation model 400 may input the feature vector h(X) and a specific integer to the intermediate network 420 to obtain a first (1) latent vector Z1 (S420). Herein, the specific integer may be 0. The intermediate network 420 may include at least one attention layer and at least one feed-forward network. For example, the intermediate network 420 may include an attention layer including a self-attention layer and a cross-attention layer and a feed-forward network. The translation model 400 may input the feature vector h(X) and 0 to the self-attention layer, the first feed-forward network, the cross-attention layer, and the second feed-forward network in sequence to obtain the first (1) latent vector Z1.

The intermediate network 420 may perform functions corresponding to the intermediate network 320 and the decoder 330 of FIG. 3. However, unlike the translation model 300 of FIG. 3 in which the intermediate network 320 and the decoder 330 are separately modeled, the intermediate network 320 and the decoder 330 may be modeled as one model in the intermediate network 420. Accordingly, the size of the model and the memory usage of the translation model 400 may be smaller than those of the translation model 300 of FIG. 3.

When the first (1) latent vector Z1 is obtained, the translation model 400 may input the first (1) latent vector Z1 to the feed-forward network 430 to obtain a first (2) latent vector Z1′ (S430). The first (2) latent vector Z1′ may be a vector obtained by deforming a dimension of the vector from the first (1) latent vector Z1. The prior model, the posterior model, and the decoder with different types or sizes of the output are integrated, and accordingly, the translation model 400 may use the feed-forward network 430, in order to adjust the type or the size of the input for the intermediate network 420.

The translation model 400 may input the feature vector h(X) and the first (2) latent vector Z1′ to the intermediate network 420 to obtain a second latent vector Z2 (S440). The translation model 400 may input the second latent vector Z2 to the decoding block 440 to obtain information on the output sentence Y (S460).

When the information on the output sentence Y is obtained, the translation model 400 may perform an operation for updating or refining the information on the output sentence Y. Herein, the information on the output sentence Y may include a vector corresponding to the output sentence Y. The translation model 400 may input a vector corresponding to the output sentence Y to the feed-forward network 450 to adjust the type or size of the vector. The translation model 400 may input a vector corresponding to the output sentence Y with the adjusted type or size and the feature vector h(X) to the intermediate network 420 to obtain a new latent vector (not illustrated). The translation model 400 may adjust the size of the new latent vector by allowing the new latent vector to pass through the feed-forward network 430, and input the new latent vector with the adjusted size and the feature vector h(X) to the intermediate network 420 to obtain a third latent vector Z3. The translation model 400 may input the third latent vector Z3 to the decoding block 440 to obtain a new output sentence.

Accordingly, the new output sentence corresponding to the output sentence Y obtained at the previous time point may be obtained. When the new output sentence is obtained, the translation model 400 may obtain a similarity between the output sentence Y obtained at the previous time point and the new output sentence. For example, the translation model 400 may calculate a similarity between the first vector corresponding to the output sentence Y and the second vector corresponding to the new output sentence. The translation model 400 may repeat the operations S420, S430, S440, and 5450 until the calculated similarity is equal to or more than the predetermined value. Alternatively, the translation model 400 may repeat the operations S420, S430, S440, and 5450 by the predetermined number of times (e.g., five times).

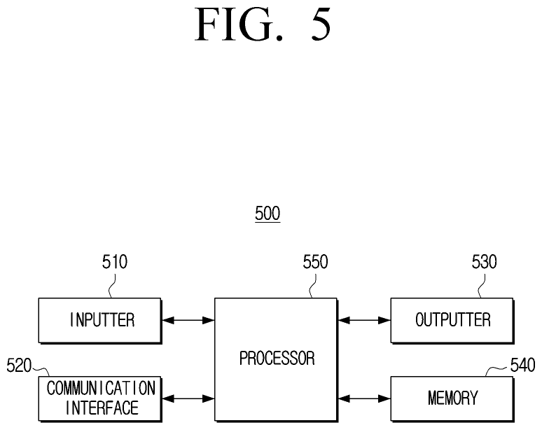

FIG. 5 is a block diagram illustrating a configuration of an electronic device according to an embodiment of the disclosure. An electronic device 500 may include an inputter 510, a communication interface 520, an outputter 530, a memory 540, and a processor 550. For example, the electronic device 500 may be a smartphone, but not limited thereto, and may be implemented as various devices such as a tablet personal computer (PC) or a wearable device.

Referring to FIG. 5, an inputter 510 may refer to means for inputting data for controlling an electronic device 500 by a user. For example, the inputter 510 may be a key pad, a dome switch, a touch pad (a contact-type capacitance type, a pressure-type resistance film type, an infrared detection type, a surface ultrasonic conduction type, an integral tensile measurement type, a piezo effect type, and the like), a jog wheel, a jog switch, or the like, but is not limited thereto. The processor 550 may obtain a text corresponding to at least one sentence input by the user through the inputter 510.

The inputter 510 may include a microphone. The processor 550 may obtain a voice signal of the user obtained via the inputter 510 and obtain a text corresponding to the voice signal.

The communication interface 520 may include at least one circuitry and communicate with various types of external devices according to various types of communication methods. The communication interface 520 may perform data communication in a wireless or wired manner. When communicating with an external device by the wireless communication method, the communication interface 520 may include at least one of a Wi-Fi communication module, a cellular communication module, a 3rd generation (3G) mobile communication module, a 4th generation (4G) mobile communication module, a 4th generation long term evolution (LTE) communication module, and a 5th generation (5G) mobile communication module. Meanwhile, according to an embodiment of the disclosure, the communication interface 520 may be implemented as a wireless communication module, but this is merely an embodiment, and the communication interface may be implemented as a wired communication module (e.g., local area network (LAN) or the like).

The outputter 530 may be an element for outputting and providing a translated sentence obtained through the electronic device 500 to the user. For example, the outputter 530 may include a display and a speaker. If the outputter 530 is a display, the outputter 530 may display the translated sentence (or output sentence). If the outputter 530 is a speaker, the outputter 530 may output a voice signal corresponding to the translated sentence.

The memory 540 may store an operating system (OS) for controlling general operations of constituent elements of the electronic device 500 and instructions or data related to the constituent elements of the electronic device 500. For this, the memory 540 may be implemented as a non-volatile memory (e.g., a hard disk, a solid state drive (SSD), or a flash memory), a volatile memory, and the like. The memory 540 may store a translation model for translating an input sentence.

The processor 550 may control general operations of the electronic device 500.

For example, the processor 550 may obtain the input sentence in a first language via the inputter 510.

The processor 550 may obtain a translation model stored in the memory 540 and obtain an output sentence in a second language from the input sentence by using the obtained translation model. Herein, the translation model may include an encoder model, an intermediate network, and a decoder model.

The processor 550 may input the input sentence to the encoder model to obtain a feature vector corresponding to the input sentence. The encoder model may include an attention layer and a feed-forward network. The processor 550 may input the input sentence to the attention layer to obtain a weight vector for the input sentence, and input the weight vector to the feed-forward network to obtain the feature vector.

The processor 550 may input the feature vector and a specific integer to the intermediate network to obtain a first latent vector. The processor 550 may input the first latent vector to the decoder model to obtain information on a first output sentence in a second language different from the first language. The information on the first output sentence may include a vector corresponding to the first output sentence.

The processor 550 may input the feature vector and information on the first output sentence to the intermediate network to obtain a second latent vector. The processor 550 may input the second latent vector to the decoder model to obtain information on a second output sentence in the second language. The information on the second output sentence may include the vector corresponding to the second output sentence.

The processor 550 may obtain a similarity between the first output sentence and the second output sentence. For example, the processor 550 may obtain a first vector corresponding to the first output sentence and a second vector corresponding to the second output sentence, and obtain a similarity between the first vector and the second vector.

If the obtained similarity is smaller than a predetermined value, the processor 550 may obtain a new output sentence based on the information on the second output sentence and the feature vector. For example, the processor 550 may input the feature vector and the information on the second output sentence to the intermediate network to obtain a third latent vector. In addition, the processor 550 may input to the third latent vector to the decoder model to obtain a third output sentence.

Meanwhile, the intermediate network may include the decoder model. In this case, the processor 550 may input the feature vector and the first latent vector to the intermediate network to obtain an intermediate latent vector, and decode the intermediate latent vector to obtain the information on the first output sentence.

Meanwhile, the function related to the artificial intelligence according to the disclosure may be operated through the processor 550 and the memory 540. The processor 550 may be formed of one or a plurality of processors. The one or the plurality of processors may be a general-purpose processor such as a central processing unit (CPU), an application processor (AP), a digital signal processor (DSP), or the like, a graphic dedicated processor such as a graphics processing unit (GPU), a vision processing unit (VPU), or the like, or an artificial intelligence dedicated processor such as an numeric processing unit (NPU), or the like. The one or the plurality of processors may perform control to process the input data according to a predefined action rule stored in the memory 540 or an artificial intelligence model. In addition, if the one or the plurality of processors are artificial intelligence dedicated processors, the artificial intelligence dedicated processor may be designed to have a hardware structure specialized in processing of a specific artificial intelligence model.

The predefined action rule or the artificial intelligence model is formed through training. Being formed through training herein may, for example, imply that a predefined action rule or an artificial intelligence model set to perform a desired feature (or object) is formed by training a basic artificial intelligence model using a plurality of pieces of learning data by a learning algorithm. Such training may be performed in a device demonstrating artificial intelligence according to the disclosure or performed by a separate server and/or system. Examples of the learning algorithm include supervised learning, unsupervised learning, semi-supervised learning, or reinforcement learning, but is not limited to these examples.

The artificial intelligence model is formed through training. Being formed through training herein may, for example, imply that a predefined action rule or an artificial intelligence model set to perform a desired feature (or object) is formed by training a basic artificial intelligence model using a plurality of pieces of learning data by a learning algorithm. The artificial intelligence model may include a plurality of neural network layers. The plurality of neural network layers have a plurality of weight values, respectively, and execute neural network processing through a processing result of a previous layer and processing between the plurality of weights. The plurality of weights of the plurality of neural network layers may be optimized by the training result of the artificial intelligence model. For example, the plurality of weight values may be updated to reduce or minimize a loss value or a cost value obtained by the artificial intelligence model during the training process.

The electronic device 500 according to the disclosure may perform machine translation for the input sentence to obtain the output sentence. For example, the electronic device 500 may receive a voice signal which is an analogue signal through the microphone and convert a voice part into a text readable by a computer by using an automatic speech recognition (ASR) model. The converted text may be analyzed to obtain intent of the user's utterance by using a natural language understanding (NLU) method. The ASR model or the NLU model may be an artificial intelligence model. The artificial intelligence model may be processed by an artificial intelligence dedicated processor designed with a specific hardware structure in the processing of the artificial intelligence model. The artificial intelligence model may be formed through training. Being formed through training herein may, for example, imply that a predefined action rule or an artificial intelligence model set to perform a desired feature (or object) is formed by training a basic artificial intelligence model using a plurality of pieces of learning data by a learning algorithm. The artificial intelligence model may include a plurality of neural network layers. The plurality of neural network layers have a plurality of weight values, respectively, and execute neural network processing through a processing result of a previous layer and processing between the plurality of weights.

In particular, the language understanding is a technology of recognizing languages/alphabets of human and applying/processing it and includes natural language processing, machine translation, a dialogue system, question and answer, speech recognition/synthesis, and the like.

The artificial neural network may include deep neural network (DNN), and, for example, include a convolutional neural network (CNN), a deep neural network (DNN), a recurrent neural network (RNN), a generative adversarial network (GAN), a restricted Boltzmann machine (RBM), a deep belief network (DBN), a bidirectional recurrent deep neural network (BRDNN), or deep Q-network, but there is no limitation to these examples.

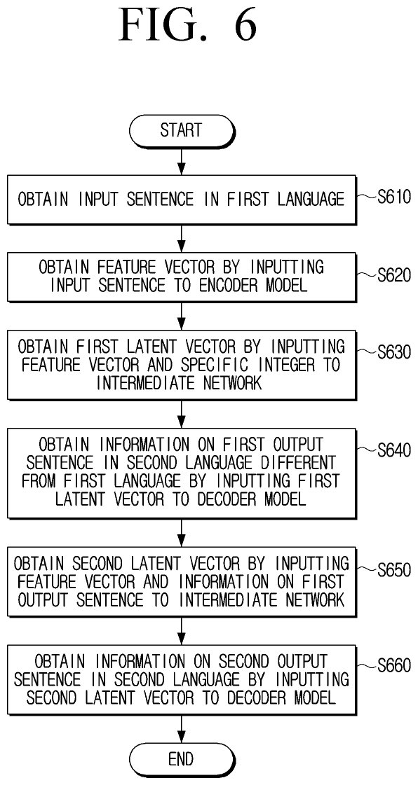

FIG. 6 is a flowchart illustrating a method for controlling an electronic device according to an embodiment of the disclosure.

Referring to FIG. 6, an electronic device 500 may obtain an input sentence in a first language at operation S610 and obtain a feature vector by inputting an input sentence to an encoder model at operation S620. The electronic device 500 may obtain a first latent vector by inputting the feature vector and a specific integer to an intermediate network at operation S630. The electronic device 500 may obtain information on a first output sentence in a second language different from the first language by inputting the first latent vector to a decoder model at operation S640.

The electronic device 500 may obtain a second latent vector by inputting the feature vector and the information on the first output sentence to the intermediate network at operation S650. The electronic device 500 may obtain information on a second output sentence in the second language by inputting the second latent vector to the decoder model at operation S660. The electronic device 500 may obtain a similarity between the first output sentence and the second output sentence. When the obtained similarity is smaller than a predetermined value, the electronic device 500 may obtain a new output sentence based on the information on the second output sentence and the feature vector. For example, the electronic device 500 may obtain a third latent vector by inputting the feature vector and the information on the second output sentence to the intermediate network, and obtain a third output sentence by inputting the third latent vector to the decoder model.

If the obtained similarity is more than the predetermined value, the electronic device 500 may obtain a text corresponding to the second output sentence based on the information on the second output sentence. In addition, the electronic device 500 may output and provide the obtained text to the user. For example, the electronic device 500 may display the obtained text and output a voice signal corresponding to the obtained text.

Meanwhile, the embodiments described above may be implemented in a recording medium readable by a computer or a similar device using software, hardware, or a combination thereof. In some cases, the embodiments described in this specification may be implemented as a processor itself. According to the implementation in terms of software, the embodiments such as procedures and functions described in this specification may be implemented as separate software modules. Each of the software modules may perform one or more functions and operations described in this specification.

Computer instructions for executing processing operations according to the embodiments of the disclosure descried above may be stored in a non-transitory computer-readable medium. When the computer instructions stored in such a non-transitory computer-readable medium are executed by the processor, the computer instructions may allow a specific machine to execute the processing operations according to the various embodiments described above.

The non-transitory computer-readable medium is not a medium storing data for a short period of time such as a register, a cache, or a memory, but may refer to a medium that semi-permanently stores data and is readable by a machine. Specific examples of the non-transitory computer-readable medium may include a compact disc (CD), a digital versatile disc (DVD), a hard disk drive, a Blu-ray disc, a universal serial bus (USB), a memory card, and a disc read only memory (ROM).

The machine-readable storage medium may be provided in a form of a non-transitory storage medium. Here, the “non-transitory recording medium” is tangible and may not include signals (e.g., electromagnetic wave), and this term does not distinguish that data is semi-permanently or temporarily stored in the storage medium. For example, the “non-transitory storage medium” may include a buffer temporarily storing data.

According to an embodiment, the methods according to various embodiments disclosed in this disclosure may be provided in a computer program product. The computer program product may be exchanged between a seller and a purchaser as a commercially available product. The computer program product may be distributed in the form of a machine-readable storage medium (e.g., compact disc read only memory (CD-ROM)) or distributed online (e.g., downloaded or uploaded) through an application store (e.g., PlayStore™) or directly between two user devices (e.g., smartphones). In a case of the on-line distribution, at least a part of the computer program product (e.g., downloadable application) may be at least temporarily stored or temporarily generated in a machine-readable storage medium such as a memory of a server of a manufacturer, a server of an application store, or a relay server.

While the disclosure has been shown and described with reference to various embodiments thereof, it will be understood by those skilled in the art that various changes in form and details may be made therein without departing from the spirit and scope of the disclosure as claimed by the appended claims and their equivalents.

1. An electronic device comprising:
an inputter configured to obtain an input sentence in a first language;
a memory storing at least one instruction; and
a processor,
wherein the processor is configured to:
obtain a feature vector corresponding to the input sentence by inputting the input sentence to an encoder model,
obtain a first latent vector by inputting the feature vector and a specific integer to an intermediate network,
obtain information on a first output sentence in a second language different from the first language by inputting the first latent vector to a decoder model,
obtain a second latent vector by inputting the feature vector and the information on the first output sentence to the intermediate network, and
obtain information on a second output sentence in the second language by inputting the second latent vector to the decoder model.

2. The electronic device of claim 1,
wherein the encoder model comprises an attention layer and a feed-forward network, and
wherein the processor is further configured to:
obtain a weight vector for the input sentence by inputting the input sentence to the attention layers, and
obtain the feature vector by inputting the weight vector to the feed-forward network.

3. The electronic device of claim 1, wherein the processor is further configured to:
obtain a similarity between the first output sentence and the second output sentence, and
based on the obtained similarity being smaller than a predetermined value, obtain a new output sentence based on the information on the second output sentence and the feature vector.

4. The electronic device of claim 3, wherein the processor is further configured to:
obtain a first vector corresponding to the first output sentence and a second vector corresponding to the second output sentence, and
obtain a similarity between the first vector and the second vector.

5. The electronic device of claim 3, wherein the processor is further configured:
obtain a third latent vector by inputting the feature vector and the information on the second output sentence to the intermediate network, and
obtain a third output sentence by inputting the third latent vector to the decoder model.

6. The electronic device of claim 1, wherein the processor is further configured to:
obtain an intermediate latent vector by inputting the feature vector and the first latent vector to the intermediate network, and
obtain the information on the first output sentence by decoding the intermediate latent vector.

7. A method for controlling an electronic device, the method comprising:
obtaining an input sentence in a first language;
obtaining a feature vector by inputting the input sentence to an encoder model;
obtaining a first latent vector by inputting the feature vector and a specific integer to an intermediate network;
obtaining information on a first output sentence in a second language different from the first language by inputting the first latent vector to a decoder model;
obtaining a second latent vector by inputting the feature vector and the information on the first output sentence to the intermediate network; and
obtaining information on a second output sentence in the second language by inputting the second latent vector to the decoder model.

8. The method of claim 7,
wherein the encoder model comprises an attention layer and a feed-forward network, and
wherein the obtaining of the feature vector comprises:
obtaining a weight vector for the input sentence by inputting the input sentence to the attention layers, and
obtaining the feature vector by inputting the weight vector to the feed-forward network.

9. The method of claim 7, further comprising:
obtaining a similarity between the first output sentence and the second output sentence; and
based on the obtained similarity being smaller than a predetermined value, obtaining a new output sentence based on the information on the second output sentence and the feature vector.

10. The method of claim 9, wherein the obtaining of the similarity comprises:
obtaining a first vector corresponding to the first output sentence and a second vector corresponding to the second output sentence, and
obtaining a similarity between the first vector and the second vector.

11. The method of claim 9, wherein the obtaining of the new output sentence comprises:
obtaining a third latent vector by inputting the feature vector and the information on the second output sentence to the intermediate network, and
obtaining a third output sentence by inputting the third latent vector to the decoder model.

12. The method of claim 7,
wherein outputting the first output sentence comprises:
obtaining an intermediate latent vector by inputting the feature vector and the first latent vector to the intermediate network, and
obtaining the information on the first output sentence by decoding the intermediate latent vector.

13. A non-transitory computer-readable recording medium on which a program for executing the method of claim 7 on a computer is recorded.
